(19) United States
(12) Patent Application Publication
(10) Pub. No.: US 2024/0093086 A1
(43) Pub. Date: Mar. 21, 2024

(54) HYDROPHIBIC CARBON-DOTS FOR OIL TRACERS

(71) Applicant: ARAMCO SERVICES COMPANY, Houston, TX (US)

(72) Inventor: Wei Wang, Quincy, MA (US)

(73) Assignee: ARAMCO SERVICES COMPANY, Houston, TX (US)

(21) Appl. No.: 17/929,587

(22) Filed: Sep. 2, 2022

(51) Int. Cl. C09K 8/82; C09K 11/77; E21B 47/11

(52) U.S. Cl. CPC C09K 8/82; C09K 11/7728; C09K 11/7743; E21B 47/11; B82Y 20/00

(57) ABSTRACT

A composition that includes an oil-soluble carbon dot and an organic fluid is provided. The oil-soluble carbon dot includes a transition metal, a rare earth element, or a combination of both. A method of making the oil-soluble carbon dot is also provided. The method includes combining an organic reactant, an amine, a dehydrating agent, and a hydrophobic organometallic compound to form a mixture, and heating the mixture such that the oil-soluble carbon dot forms. A method of determining a flow characteristic of a formation or an attribute of a fluid in a formation using the oil-soluble carbon dots is also provided.

### BACKGROUND

Tracers are commonly used in the oil and gas industry for tracking oil and water flow patterns through reservoirs. Tracers can be injected into a reservoir, and then detected at a production well. Produced fluids are sampled to determine concentrations of the tracers that are present at the time of their arrival. The concentration data can be used to understand fluid flow patterns and to infer other properties of the reservoir, for example, pore volumes and flow characteristics.

Carbon dots (C-dots), also referred as carbon nanoparticles (C-NPs) or carbon quantum dots (CQDs), are a class of carbon nanomaterials that have attracted interest because of their water solubility, chemical inertness, low toxicity, ease of functionalization and resistance to photobleaching. When used as tracers in reservoirs, C-dots can adapt to different temperature, salinity, and pH environments in the process of revealing components of the reservoir. C-dots may exhibit strong fluorescence in visible spectral range and are readily detectable by fluorescence imaging and spectroscopy methods. However, the fluorescence emission of C-dots may have broad bands. The emission maximums vary depending on the excitation wavelength. Additionally, their hydrophilicity makes them amenable to being used as tracers in aqueous environments, but typically does not allow for them to be readily used as tracers in oil phases.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composition that includes an oil-soluble carbon dot comprising an element selected from the group consisting of a transition metal, a rare earth element, and combinations thereof, and an organic fluid.

In another aspect, embodiments disclosed herein relate to a method of preparing an oil-soluble carbon dot. The method includes combining an organic reactant, a diamine, a dehydrating agent, and a hydrophobic organometallic compound to form a mixture, and heating the mixture such that the oil-soluble carbon dot forms. The hydrophobic organometallic compound comprises an element selected from the group consisting of a transition metal, a rare earth element, and combinations thereof.

In yet another aspect, embodiments disclosed herein relate to a method of determining a flow characteristic of a formation or an attribute of a fluid in a formation. The method includes introducing an injection fluid comprising one or more oil-soluble carbon dots into an injection well associated with a formation at a first location, recovering produced fluid from a production well associated with the formation at a second location, detecting the presence of the one or more of oil-soluble carbon dots in the produced fluids, and determining at least one flow characteristic of the formation or an attribute of the fluid in the formation between the first and the second location based upon the detection of the one or more oil-soluble carbon dots.

Other aspects and advantages of the claimed subject matter will be apparent from the following description and the appended claims.

### BRIEF DESCRIPTION OF DRAWINGS

FIG. 1 is a reaction scheme in accordance with one or more embodiments of the present disclosure.

FIG. 2 is a schematic of a reservoir in accordance with one or more embodiments of the present disclosure.

FIG. 3 is a block flow diagram of a method in accordance with one or more embodiments of the present disclosure.

FIG. 4 is a block flow diagram of a method in accordance with one or more embodiments of the present disclosure.

FIG. 5 is a block flow diagram of a method in accordance with one or more embodiments of the present disclosure.

### DETAILED DESCRIPTION

Tracer studies can be used to collect data for subsurface fluid flow analysis. In a tracer study, one or more tracers may be injected at an injection site of the reservoir. The tracer may mix with the fluid in the subsurface under the injection site. For example, the tracer may diffuse into the fluid or may mix with the fluid due to advection. After some time, samples of the fluid may be collected at a producing site for analysis. The propagation patterns of the one or more tracers between the injecting site and the producing site may be used to determine the presence and location of flow barriers and fractures between the two sites in the reservoir as well as management of fluids flowing the formation. In some cases, multiple injection sites and multiple producing sites may be selected in a reservoir. Tracers may be injected in each of the multiple injection sites and fluid samples may be collected at each of the multiple producing sites to analyze the fluid movement pattern of at least a portion of the reservoir. Tracers may also be introduced into a circulating stream of drilling fluid at different interval times and then samples of the drilling fluid may be collected based upon the rate of circulation at different times to analyze the fluid traveling time correlating to deeps in drilling operation.

Embodiments of the present disclosure generally relate to a composition used as a tracer in hydrocarbon-bearing formations. The composition comprises a carbon dot, also referred to as a carbon nanoparticle, that includes at least one transition metal or rare earth element. Disclosed carbon dots may be hydrophobic and soluble in an oil phase. Due to their fluorescent properties, the disclosed compositions may be used in downhole fluid flow analysis applications and in drilling fluids as tracers.

### Carbon Dot Tracer Composition

In one aspect, embodiments disclosed relate to a tracer composition having a

modified carbon dot. As used here, “carbon dot” means a carbon nanoparticle. As used herein, “carbon nanoparticle” means a carbon particle having nanoscale dimensions, meaning a diameter of less than one hundred nanometers. Carbon dots in accordance with the present disclosure include the reaction product of an organic reactant, a diamine, a dehydrating agent, and an organometallic compound. The organometallic compound may include a rare earth element, a transition metal element, or a combination thereof.

Carbon dots of the disclosed composition may have an appropriate average particle size for use as a tracer in a reservoir. In some embodiments, the average carbon dot particle diameter may have a range of from about 5 nm (nanometers) to about 100 nm as measured via transmission electron microscopy. Unless indicated otherwise, average particle size refers to the particle size as measured via transmission electron microscopy. The average carbon dot particle diameter may have a lower limit of one of 5, 10, 15, 20, 30, and 40 nm, and an upper limit of one of 50, 60, 70, 80, 90, and 100 nm, where any lower limit may be paired with any upper limit.

Carbon dot particles may have any shape suitable for use as a tracer. In one or more embodiments, the carbon dots are spherical. In one or more embodiments the carbon dots may have a geometric shape that is not spherical, such as, but not limited to, cubic, rhomboidal, elliptical, or pyramidal. In one or more embodiments, the carbon dots may have an irregular shape.

Carbon dots of the present disclosure may have a suitable surface chemistry for dispersion in particular solvents. In one or more embodiments, the carbon dots may be hydrophobic and soluble in oil. Such oil-soluble carbon dots may be transferred from one fluid to another, such as, for example, from a microemulsion to crude oil.

Carbon dots of the present disclosure may be modified to include at least one rare earth element or at least one transition metal element. As used here, “modified carbon dot” means a carbon dot that includes at least one rare earth or transition metal element. In one or more embodiments, carbon dots may include at least one of a rare earth element or a transition metal element.

In one or more embodiments, the rare earth element may comprise at least one member of the Lanthanide periodic series of elements. In one or more embodiments, the rare earth element may comprise at least one member of the Actinide periodic series of elements. A rare earth element may be selected from the group consisting of La³⁺, Ce^{3+/4+}, Pr³⁺, Nd³⁺, Pm³⁺, Sm³⁺Eu³⁺, Gd³⁺, Tb³⁺, Dy³⁺, Ho³⁺, Er³⁺, Tm³⁺, Yb³⁺, Lu³⁺, Th³⁺, U⁴⁺, and combination thereof. Ionic species of rare earth elements are listed to indicate their charge when present as ions in a solution, however, as will be understood by those skilled in the art, the rare earth elements may be present in a neutral state in one or more embodiments. In particular, in embodiments in which the rare earth element is included in a modified carbon dot, the rare earth element may be in a neutral state.

In one or more embodiments, the transition metal element may comprise at least one member of the transition metal periodic groups of elements. In one or more embodiments, the transition metal element may comprise at least one member of the post-transition metal periodic groups of elements. A transition metal element may be selected from the group consisting of Sc³⁺, Ti³⁺, V⁴⁺, Cr³⁺, Mn³⁺, Fe³⁺, Co³⁺, Ni²⁺, Cu²⁺, Zn²⁺, Ga³⁺, Ge⁴⁺, Sr²⁺, Y²⁺, Zr⁴⁺, Nb³⁺, Ru⁴⁺, Pd²⁺, Cd²⁺, Sn⁴⁺, Hf⁴⁺, Bi³⁺, and combinations thereof. Ionic species of transition metal elements are listed to indicate their charge when present as ions in a solution, however, as will be understood by those skilled in the art, the transition metal elements may be present in a neutral state in one or more embodiments. In particular, in embodiments in which the transition metal element is included in a modified carbon dot, the transition metal element may be in a neutral state.

Carbon dots may include a suitable amount of rare earth or transition metal elements for use as a tracer. In one or more embodiments, the carbon dot composition may include a range of from about 0.5 wt. % (weight percent) to about 50 wt. % of rare earth or transition metal elements. The amount of rare earth or transition metal element may have a lower limit of one of 0.5, 1.0, 2.0, 5.0, 10.0 and 15.0 wt. %, and an upper limit of one of 20.0, 25.0, 30.0, 40.0, 45.0 and 50.0 wt. %, where any lower limit may be paired with any upper limit.

Carbon nanoparticles, such as the carbon dots, may fluoresce when exposed to UV (ultraviolet) or visible radiation. When carbon dots are modified to include a rare earth element, a transition metal element, or both, the modified carbon dots maintain the fluorescence properties of the carbon dot and may possess new or improved fluorescent properties when exposed to UV or visible radiation versus without such rare earth or transition metal modification. The inclusion of rare earth elements, transition metal elements, or both may not measurably change the fluorescence properties of the carbon nanoparticles. In some cases, the wavelength of fluorescence may be tuned by selecting a particular rare earth or transition metal element in combination with a particular chelating agent. The fluorescent properties allow the disclosed modified carbon dots to be used as tracers because they may be readily detected via spectroscopic techniques in collected samples from a producing well. Additionally, different types of tracers, meaning tracers that contain different rare earth or transition metal elements, may be readily detected via inductively coupled plasma optical emission spectroscopy (ICP-OES) or inductively coupled plasma-mass spectrometry (ICP-MS) techniques to obtain more complex information about reservoir properties. As each rare earth or transition metal element has a particular signature when detected via ICP-OES or ICP-MS, the rare earth or transition metal elements may act as “barcodes” for identification purposes. Thus, the disclosed modified carbon dots may be detected via fluorescence spectroscopy due to the presence of carbon nanoparticles and may further be quantified due to the presence of rare earth and/or transition metal elements.

### Method of Preparing Carbon Dot Tracer

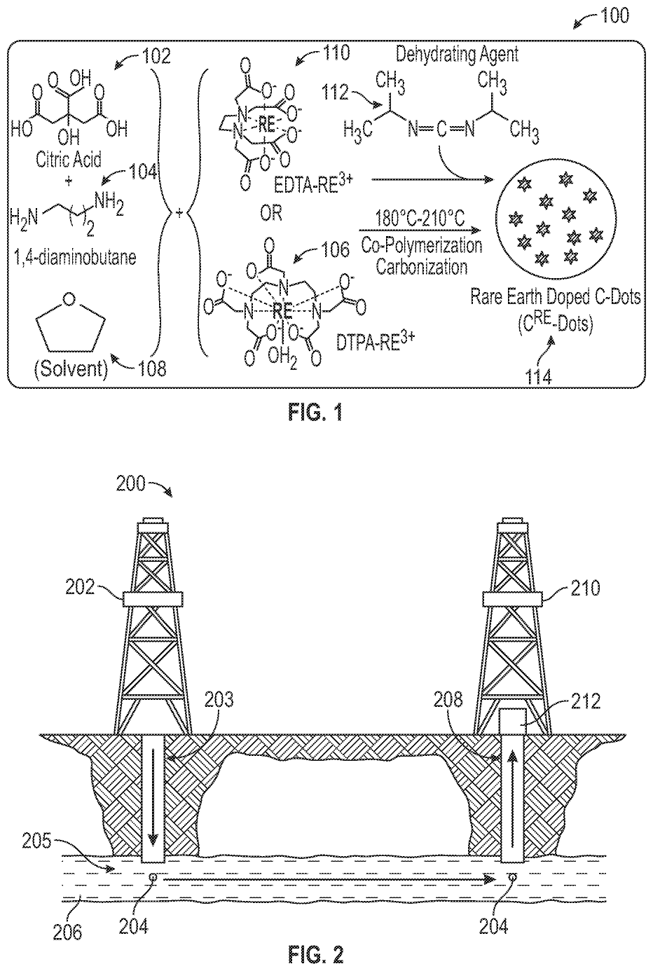

In another aspect, embodiments disclosed herein relate to a method of preparing the previously disclosed oil-soluble carbon dots. In one or more embodiments, the carbon dots are synthesized using a one pot chemical synthesis method. A reaction scheme of an embodiment method is shown in FIG. 1. In the disclosed one pot chemical synthesis method 100, an organic reactant 102, a diamine 104, an organometallic compound 106, and a solvent 108, are combined to form an initial mixture 110.

In one or more embodiments, the organic reactant 102 includes at least one hydroxyl group. Types of organic reactants may include organic acids and saccharides. In one or more embodiments, the organic reactant is selected from the group consisting of citric acid, glucose, and combinations thereof. The organic reactant may be included in the initial mixture in an amount of from 50 to 98 wt. % (weight percent) as compared to the weight of the organometallic compound. For example, the organic reactant may be included in the initial mixture in an amount ranging from a lower limit of one of 50, 55, 60, 65, 70 and 75 wt. % to an upper limit of one of 75, 80, 85, 90, 95 and 98 wt. %, where any lower limit may be paired with any mathematically compatible upper limit.

As described above, a diamine 104 may be included in the initial mixture 110. Suitable diamines include, but are not limited to, 1,4-diaminobutane, 4-amino-1-butanol, 1,3-diaminopropane, 3-amino-1-propanol, 1,2-Diaminoethane, ethanolamine, 1,2-diaminobenzene, 1,3-diaminobenzene, 1,4-diaminobenzene, 1-amino-2-hydroxybenzene, 1-amino-3-hydroxybenzene, and 1-amino-4-hydroxybenzene.

The organic reactant and the diamine may be present in an appropriate ratio for achieving suitable nanoparticle fluorescence. In one or more embodiments, the molar ratio of the organic reactant to the diamine may be about 1:1 or about 1:2 or about 1:3.

As described above, an organometallic compound 106 may be included in the initial mixture 110. The organometallic compound may include a rare earth or transition metal element as previously described, bonded to an organic ligand. Organic ligands suitable for the disclosed organometallic compounds may be referred to as chelating agents. Chelating agents bind strongly with metal ions to form an organometallic compound. In one or more embodiments, the organic ligand is a hydrophobic chelating agent such as a β-diketone. A general structure of a β-diketone is shown in Formula I.

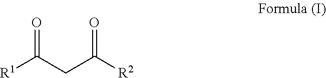

where R¹ and R² are each independently a hydrogen, an alkyl or an aromatic group.

Suitable β-diketones include, but are not limited to, acetylacetone (acac), hexafluoroacetylacetone (hfac), 3,5-heptanedione, 2,2,6,6-tetramethyl-3,5-heptanedione, 1-(Thiophen-2-yl)butane-1,3-dione, 4,4,4-Trifluoro-1-(2-thienyl)-1,3-butanedione, 4,4,4-Trifluoro-1-(2-furyl)-1,3-butanedione, 1-Phenyl-1,3-butanedione, 4,4,4-Trifluoro-1-phenyl-1,3-butanedione, 4,4,4-Trifluoro-1-(4-methylphenyl)butane-1,3-dione, 4,4,4-Trifluoro-1-(2-naphthyl)-1,3-butanedione, 1,3-Diphenyl-1,3-propanedione, 1,3-Di(2-pyridyl)-1,3-propanedione, and combinations thereof. In one or more embodiments, the molar ratio of rare earth or transition metal element to chelating agent ranges from 1:2 to 1:4.

The initial mixture 110 may also include a solvent. Suitable solvents include acetone, ethyl acetate, acetonitrile, methanol, ethanol, and tetrahydrofuran, among others. The solvent may be included in the mixture in an amount ranging from 50 to 95% by weight of the total weight of the mixture.

In method 100, the initial mixture 110 may be heated to an elevated temperature for a sufficient amount of time. In one or more embodiments, the initial mixture is heated to an elevated temperature ranging from about 180 to about 210° C. For example, the elevated temperature may range from a lower limit of one of 180, 185, 190, and 195° C. to an upper limit of one of 195, 200, 205, and 210° C., where any lower limit may be paired with any mathematically compatible upper limit. In this temperature range, copolymerization and carbonization of the organic material in the reaction takes place. The initial mixture may be heated for a sufficient amount of time to initiate copolymerization and carbonization, which may range from about 1 to 6 hours. For example, the initial mixture may be heated for an amount of time ranging from a lower limit of one of 1.0, 1.5 2.0, 2.5, and 3.0 hours to an upper limit of one of 3.5, 4.0, 4.5, 5.0, 5.5, and 6.0 hours, where any lower limit may be paired with any upper limit.

As the components of the reaction mixture are heated, components of the mixture first undergo copolymerization and then carbonization. Copolymerization is a step in which at least two reaction components, such as the organic reactant, the alkoxy amine, and the organometallic compound, may polymerize to form a polymer structure. In one or more embodiments, the amine groups on the diamine, the carboxylic acid groups on the organic reactant, and the hydroxyl groups on the organic reactant may react to form a polymer structure.

As the reaction progresses at the previously described elevated temperature, the polymer structure may be carbonized to form the carbon dot structure. In the carbonization process, functionality such as amine and hydroxyl groups are partially removed, leaving a structure that is largely composed of amorphous carbon and the previously described rare earth or transition metal elements.

The initial mixture, once sufficiently reacted, may be cooled to ambient temperature. Then, method 100 includes adding a dehydrating agent 112 to the initial mixture 110. The dehydrating agent may be added to the initial mixture during the carbonization and copolymerization, such that the hydrophilic groups on the surface of the formed carbon dots are reduced or eliminated. Inclusion of a dehydrating agent may provide a carbon dot having a hydrophobic surface. In one or more embodiments, the dehydrating agent is a carbodiimide such as N,N′-Diisopropylcarbodiimide (DIC), dicyclohexylcarbodiimide (DDC), or a combination thereof.

After the dehydrating agent 112 is added to the initial mixture 110, the reaction may once again be heated to an elevated temperature for a sufficient amount of time to provide the oil-soluble carbon dots 114. In one or more embodiments, the reaction is heated to an elevated temperature ranging from about 180 to 210° C. for about 1 to 6 hours. For example, the elevated temperature may range from a lower limit of one of 180, 185, 190, and 195° C. to an upper limit of one of 195, 200, 205, and 210° C., where any lower limit may be paired with any mathematically compatible upper limit and the amount of time may range from a lower limit of one of 1.0, 1.5 2.0, 2.5, and 3.0 hours to an upper limit of one of 3.5, 4.0, 4.5, 5.0, 5.5, and 6.0 hours, where any lower limit may be paired with any upper limit. The reaction may be considered complete once the desired fluorescent of the carbon dots is achieved.

### Injection Fluid Composition

In yet another aspect, the present disclosure relates to an injection fluid composition including one or more previously described oil-soluble carbon dots. Embodiment injection fluid compositions may be used in hydrocarbon-bearing formations. The injection fluid may be, for example, a fracturing fluid or a drilling fluid.

In one or more embodiments, the injection fluid is an emulsion including an aqueous continuous phase and an oil-based discontinuous phase. Due to the presence of the oil-based discontinuous phase, carbon dots disclosed herein may be soluble in such an emulsion. In one or more embodiments, the aqueous continuous phase of the emulsion includes water. The water may comprise one or more known compositions of water, including distilled; condensed; filtered or unfiltered fresh surface or subterranean waters, such as water sourced from lakes, rivers, or aquifers; mineral waters; gray water; run-off, storm or wastewater; potable or non-potable waters; brackish waters; synthetic or natural sea waters; synthetic or natural brines; formation waters; production water; and combinations thereof.

The oil-based discontinuous phase of the emulsion may include any oil-based fluid suitable to solubilize the modified carbon quantum dots in the emulsion. For example, in one or more embodiments, the oil-based phase may be crude oil, condensates, light hydrocarbon liquids, fractions thereof, derivatives thereof, and others. In one or more embodiments, the oil phase may include a dearomatized mineral oil such as Safra oil (SaudiSol, Gulf Chemicals and Industrial Oils Co., Saudi Arabia). In one or more embodiments, the oil-based phase ranges from 60 to 98 vol % of the overall composition volume.

In one or more embodiments, the emulsion includes one or more surfactants. Surfactants may be included in the emulsion to stabilize the modified carbons dots. Suitable surfactants include, but are not limited to, sodium dodecyl sulfate (SDS), sodium dodecylbenzene sulfonate (SDBS), cetyltrimethylammonium bromide (CTAB), and cetyltrimethylammonium chloride (CTAC). In one or more embodiments, the surfactant may be included in an amount ranging from 0.1 to 3.0 wt. % based on the total weight of the emulsion.

In other embodiments, the injection fluid is an oil-based fluid. Due to the unique oil-solubility of the modified carbon dots, the injection fluid may be any oil-based fluid known in the art, such as, for example, oil-based drilling mud.

One or more carbon dots may be present in the injection fluid in an appropriately high concentration such that when injected as a tracer composition in a formation, the tracer chemicals are produced from the well at a part per billion (ppb) concentration. In one or more embodiments, the concentration of carbon nanoparticles in the injection fluid may be from about 10,000 ppm (parts per million) to about 100,000 ppm. The concentration of carbon nanoparticles in the emulsion may range from a lower limit of one of 10,000, 20,000, 30,000, 40,000 and 50,000 ppm to an upper limit of one of 60,000, 70,000, 80,000, 90,000 and 100,000 where any lower limit may be paired with any mathematically compatible upper limit.

### Method for Monitoring Produced Oil in a Flooding Process

In another aspect, one or more embodiments relate to a method for monitoring produced hydrocarbons from a target zone of a hydrocarbon-bearing formation using an injection fluid including oil-soluble carbon dots, as described above.

FIG. 2 is a schematic diagram that illustrates a hydrocarbon bearing formation 200 in which the disclosed modified carbon dots may be used. The formation 200 includes a first wellbore drilling system 202 located at an injection site. An injection fluid including one or more oil-soluble carbon dots 204 may be injected into the first wellbore 203 to a target zone 205 such that they mix with subsurface fluid 206. The formation 200 also includes a second wellbore drilling system 210 located at a producing site. Subsurface fluid 206 may be extracted at the second wellbore 208 at the producing site. The producing site may also include a tracer detection unit 212 on the surface to detecting the recovered tracers 204.

Hydrocarbon-bearing formations may include oleaginous fluid, such as crude oil, dry gas, wet gas, gas condensates, light hydrocarbon liquids, tars, and asphalts, as well as other hydrocarbon materials. Hydrocarbon-bearing formations may also include aqueous fluid such as water and brines. Embodiment oil-soluble carbon dots may be appropriate for use in different types of subterranean formations, such as carbonate, shale, sandstone, and tar sands.

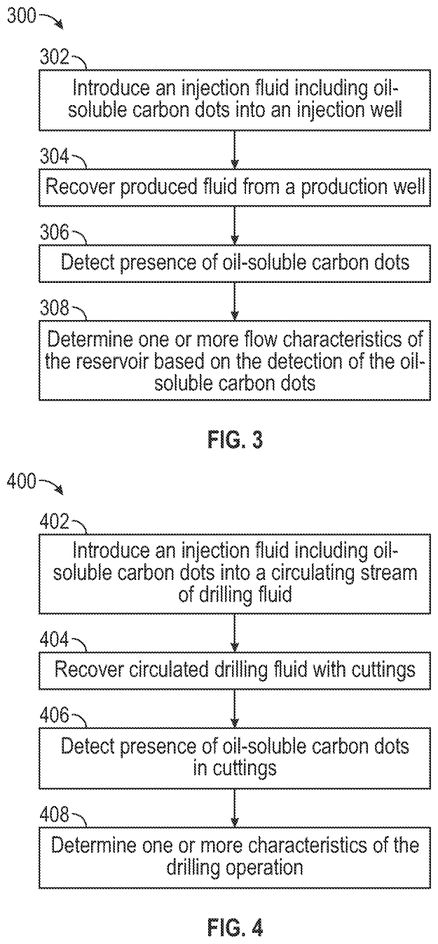

A method for monitoring oil production from a target zone 205 of a hydrocarbon-bearing formation in accordance with one or more embodiments is shown in and discussed with reference to FIG. 3. Method 300 includes injecting an injection fluid including one or more previously described oil-soluble carbon dots into target zone 205 through the wellbore 302. The injection fluid may be a fracturing fluid. As described above, once the injection fluid is injected into target zone 205, it mixes with the subsurface fluid 206. In one or more embodiments, the subsurface fluid is an oil-based fluid. In such embodiments, when the injection fluid mixes with the subsurface fluid, the oil-soluble carbon dots may transfer from the injection fluid to the subsurface fluid so that they may flow with the subsurface fluid. After an amount of time, produced fluid may be recovered from the hydrocarbon-bearing reservoir 304, and the presence of the oil-soluble carbon dot is detected via a spectroscopic technique 306 as discussed above. Based on the detection of the modified carbon dots, one or more flow characteristics of the formation may be determined 308. The oil soluble carbon dots may be suitable for use in single well chemical tracer tests (SWCTT) or interwell tracer tests.

As previously described, the oil-soluble carbon dots may be introduced into a wellbore using an injection well. As may be appreciated by those skilled in the art, depending upon the formation property that is being determined, the type(s) of tracer(s), the number of injection wells and production wells, and the time of tracer introduction may be appropriately varied in order to determine a certain property. In one or more embodiments, a single type of tracer is introduced into the injection well. In one or more embodiments, multiple types of tracers may be introduced into the same injection well at different times or in different target zones. In one or more embodiments, different types of tracers may be introduced into different injection wells.

After the oil-soluble carbon dots have been introduced into the wellbore, fluid is produced at a production well. The produced fluid may be collected at certain intervals in order to determine the presence of, and the concentration of, the modified carbon dots in the produced fluid. Fluid may be collected monthly or biweekly before the expected time of the carbon dots reaching a production well. Thereafter, once the presence of carbon dots has been confirmed in the produced fluid, produced fluid may be collected one or two times per week for analysis to determine the presence and concentration of the disclosed oil-soluble carbon dots.

As described previously, the presence of oil-soluble carbon dots in the produced fluid may be detected in the recovered fluid. Carbon dots in recovered samples may be detected via analytical techniques, such as fluorescence spectroscopy, inductively coupled plasma atomic emission spectroscopy (ICP-AES), and inductively coupled plasma mass spectrometry (ICP-MS). The presence of modified carbon dots may be detected using fluorescence spectroscopy while other techniques, such as ICP-AES and ICP-MS, may be used to quantify the amount of carbon dots even at reduced concentrations, such as in the parts per million and parts per billion range, which may be the result of fluid dilution and scattering. Techniques such as ICP-AES and ICP-MS may be used to determine the concentration of oil-soluble carbon dots in produced fluid by measuring the concentration of rare earth or transition metal elements in the sample.

The detected types and quantities of oil-soluble carbon dots along with the characteristics of the produced fluid in which the modified carbon dots are present may be used to determine fluid flow aspects within a formation. In one or more embodiments, fluid flow dynamics across wells may be determined.

As described above, in one or more embodiments, multiple different oil-soluble carbon dots may be injected into multiple injection wells. At each injection well, a unique oil-soluble carbon dot may be injected into the formation. For example, a first oil-soluble carbon may be injected into a first injection well, and subsequently, a second oil-soluble carbon dot may be injected into a second injection well. Accordingly, produced hydrocarbons in a production well may contain the first oil-soluble carbon dot, the second oil-soluble carbon dot, or both. In one or more embodiments, the first oil-soluble carbon dot and the second oil-soluble carbon dot will be present in the produced hydrocarbons from a production well at different times and/or different concentrations. The concentration of the first oil-soluble carbon dot may indicate the production related the first injection well flooding, whereas the concentration of the second oil-soluble carbon dot may indicate the production related to the second injection well flooding. The carbon dot concentration may be integrated with the oil production rates to yield map of interwell connection between injection and production wells.

### Method of Tagging Drill Cuttings

In one or more embodiments, the previously described injection fluid including one or more oil-soluble carbon dots may be a drilling fluid. In such embodiments, the drilling fluid may be introduced into the wellbore such that the oil-soluble carbon dots tag the drill cuttings at the drill bit. An embodiment method is shown in FIG. 4. The method 400 includes introducing an oil-based fluid including carbon dots into a circulating stream of drilling fluid 402. The carbon dots in drilling fluid may attach or embed onto cuttings. After an amount of time, circulated drilling fluid with the cuttings is recovered 404 and the presence of the oil-soluble carbon dots is detected 406. Based on the presence of the oil-soluble carbon dots, one or more characteristics of a drilling operation may be determined 408, such as the drilling depth being correlated to different cuttings.

Oil-soluble carbon dots disclosed herein may be utilized in oil-based drilling fluids without any additional modification. In some embodiments, oil-soluble carbon dots may be used in aqueous-based muds, however, suitable formulations, such as an emulsion of a surfactant in water, are necessary to ensure proper dispersion.

In drilling operations, an oil-based fluid including oil-soluble carbon dots may be introduced into the circulating drilling stream, and then samples of the drilling fluid with drill cuttings may be collected based upon the rate of circulation, such as on the order of minutes or hours.

Carbon dots in the drilling fluid may be detected via analytical techniques such as fluorescence spectroscopy, inductively coupled plasma atomic emission spectroscopy (ICP-AES), and inductively coupled plasma mass spectrometry (ICP-MS). Such analytical techniques are useful for detecting the presence of different tracers and their concentrations as previously described.

### Method of Monitoring Produced Oil in Fracturing Process

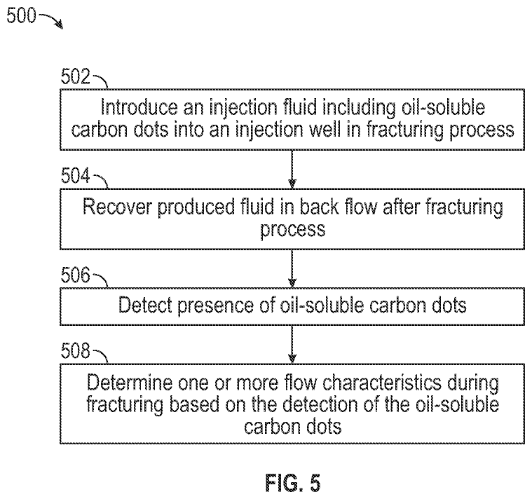

In one or more embodiments, the previously described injection fluid including one or more oil-soluble carbon dots may be a fracturing fluid. Thus, one or more embodiments relate to a method for monitoring produced hydrocarbons from a target zone of a hydrocarbon-bearing formation using an injection fracturing fluid including oil-soluble carbon dots, as described above. An embodiment method 500 is shown in FIG. 5. First, an injection fluid including an oil-soluble carbon dot is introduced into an injection well in a fracturing process 502. In some embodiments, multiple different oil-soluble carbon dots may be injected into multiple target zones in an injection well during the fracturing process. For each target zone, a unique oil-soluble carbon dot may be injected into the formation at a different time. For example, a first oil-soluble carbon dot may be injected into a first target zone at time A, and subsequently, a second oil-soluble carbon dot may be injected into a second target zone at time B, and subsequently, a third oil-soluble carbon dot may be injected into a second target zone at time C, and so on. Produced fluid in back flow is recovered after the fracturing process 504. The oil soluble carbon dots in the produced fluid are then detected 506. Accordingly, produced hydrocarbons in back flow may contain the first oil-soluble carbon dot or the second oil-soluble carbon dot at different intervals. In one or more embodiments, the first oil-soluble carbon dot and the second oil-soluble carbon dot will be present in the produced hydrocarbons at different concentrations. One or more flow characteristics during the fracturing process may be determined based on the detection of the oil-soluble carbon dots 508. The concentration of the first oil-soluble carbon dot may indicate the production from the first target zone, whereas the concentration of the second oil-soluble carbon dot may indicate the production from the second target zone. The carbon dot concentration may be integrated with the oil production rates to yield a total mass of tracer recovered from each zone.

### EXAMPLES

Citric acid monohydrate (Certified ACS, granular, Fisher); 4,4,4-trifluoro-1-(2-thienyl)-1,3-butanedione (tftbd, Sigma-Aldrich, 99%); ethanol (VWR, 95%); europium nitrate hexahydrate (Strem Chemicals, ≥99.9%); trimethylamine (TMA, Sigma-Aldrich, 40% solution); acetylacetone (Acros Organics, 99+%); methanol (VWR, ≥99.8%); terbium chloride hexahydrate (Strem Chemicals, ≥99.9%); 1,4-diaminobutane (Acros Organics, 99%); Tetrahydrofuran (THF, VWR ACS Grade); N,N′-diisopropylcarbodiimide (TCI, ≥98.0% by GC); acetonitrile (VWR, ≥99.5% ACS); and dicyclohexylcarbodiimide (BTC, ≥99%) were used in the following examples.

An iCAP 7000 spectrometer (ThermoFisher Scientific; Waltham, MA, USA) was used for ICP-OES analysis. Horiba Nanolog-3 fluorescence spectrometer or portable Ocean Optics fluorescence spectrometer was used for fluorescence analysis.

### Organometallic Complex 1

In a typical synthesis, 2.22 g (10 mmol) 4,4,4-trifluoro-1-(2-thienyl)-1,3-butanedione (tftbd) was dissolved into 20 mL of ethanol, and 1.55 g (3.33 mmol) europium nitrate hexahydrate [Eu(NO₃)₃·6H₂O] was dissolved in 10 ml of deionized water, respectively. Then Eu' solution was added to the 4,4,4-trifluoro-1-(2-thienyl)-1,3-butanedione solution drop by drop under vigorous stirring at room temperature. After 30 mins, trimethylamine (TMA) was added to the solution to adjust the pH to ˜7. Addition of base assists the removal of a proton from tftbd and promotes the reaction in favor of the complex. Finally, the solution was dried at 100° C. to obtain the complex of Eu(tftbd)₃ as a white powder.

### Organometallic Complex 2

In a typical synthesis, 1.0 g (10 mmol) acetylacetone (acacH) was dissolved in 10 ml of methanol (MeOH), and 1.24 g (3.33 mmol) of terbium chloride hexahydrate (TbCl₃·6H₂O), in water respectively. Then the Tb³⁺ solution was added drop by drop to the acacH mixture. After 30 mins, TMA was added to adjust the pH to ˜7. The resulting mixture was stirred at room temperature for 2 hours, and then was heated to slowly evaporate solvent. Dry powder of Tb(acac)3 was obtained.

### Example 1

4.2 g (20 mmol) citric acid monohydrate was dissolve in 20 mL THF, and 2.64 g (30 mmol) of 1,4-diaminobutane was added under vigorous stirring. In another 20 mL THF, 0.5 g of Organometallic Complex 1 was dissolved, and the solution was added into the solution of citric acid and 1,4-diaminobutane under stirring. The mixed solution was transferred in an autoclave and heated at 180° C. for 2 hours. After cooling to room temperature, 0.5 g N,N′-diisopropylcarbodiimide (DIC) was added to the reaction mixture in autoclave, and the autoclave was heated at 190° C. for another 2 hours. The resultant product was hydrophobic and miscible with various organic solvents, such as crude oils.

### Example 2

4.2 g (20 mmol) citric acid monohydrate was dissolve in 20 mL acetonitrile, and 2.64 g (30 mmol) of 1,4-diaminobutane was added under vigorous stirring. In another 20 mL acetonitrile, 0.5 g of Organometallic Complex 2 was dissolved, and the solution was added into the solution of citric acid and 1,4-diaminobutane under stirring. The mixed solution was transferred in an autoclave and heated at 180° C. for 2 hours. After cooling to room temperature, 0.5 g dicyclohexylcarbodiimide (DDC) was added to the reaction mixture in autoclave, and the autoclave was heated at 190° C. for another 2 hours. The result product was hydrophobic and miscible with various organic solvents, such as crude oils.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A composition comprising:
an oil-soluble carbon dot comprising an element selected from the group consisting of a transition metal, a rare earth element, and combinations thereof; and
an organic fluid.

2. The composition of claim 1, wherein the oil-soluble carbon dot has an average diameter ranging from 2 to 100 nm.

3. The composition of claim 1, wherein the carbon dot is spherical.

4. The composition of claim 1, wherein the carbon dot is fluorescent under ultraviolet light.

5. The composition of claim 1, wherein the element is a transition metal selected from the group consisting of Sc³⁺, Ti³⁺, V⁴⁺, Cr³⁺, Mn³⁺, Fe³⁺, Co³⁺, Ni²⁺, Cu²⁺, Zn²⁺, Ga³⁺, Ge⁴⁺, Sr²⁺, Y²⁺, Zr⁴⁺, Nb³⁺, Ru⁴⁺, Pd²⁺, Cd²⁺, Sn⁴⁺, Hf⁴⁺, Bi³⁺, and combinations thereof.

6. The composition of claim 1, wherein the element is a rare earth element selected from the group consisting of La³⁺, Ce³⁺, Ce⁴⁺, Pr³⁺, Nd³⁺, Pm³⁺, Sm³⁺Eu³⁺, Gd³⁺, Tb³⁺, Dy³⁺, Ho³⁺, Er³⁺, Tm³⁺, Yb³⁺, Lu³⁺, Th³⁺, U⁴⁺, and combinations thereof.

7. The composition of claim 1, wherein the element is present in the carbon dot in an amount ranging from 0.5 wt. % to 50 wt. %, based on a total weight of the carbon dot.

8. The composition of claim 1, wherein the organic fluid is crude oil.

9. A method of preparing an oil-soluble carbon dot comprising:
combining an organic reactant, a diamine, a dehydrating agent, and a hydrophobic organometallic compound to form a mixture, wherein the hydrophobic organometallic compound comprises an element selected from the group consisting of a transition metal, a rare earth element, and combinations thereof; and
heating the mixture such that the oil-soluble carbon dot forms.

10. The method of claim 9, wherein the organic reactant is selected from the group consisting of citric acid, glucose, and combinations thereof.

11. The method of claim 9, wherein the diamine is selected from the group consisting of 1,4-diaminobutane, 4-amino-1-butanol, 1,3-diaminopropane, 3-amino-1-propanol, 1,2-diaminoethane, ethanolamine, 1,2-diaminobenzene, 1,3-diaminobenzene, 1,4-diaminobenzene, 1-amino-2-hydroxybenzene, 1-amino-3-hydroxybenzene, and 1-amino-4-hydroxybenzene, and combinations thereof.

12. The method of claim 9, wherein the dehydrating agent is a carbodiimide compound selected from the group consisting of N,N′-Diisopropylcarbodiimide, dicyclohexylcarbodiimide, and combinations thereof.

13. The method of claim 9, wherein the hydrophobic organometallic compound further comprises a hydrophobic ligand.

14. The method of claim 13, wherein the hydrophobic ligand is a β-diketone selected from the group consisting of acetylacetone, hexafluoroacetylacetone, 3,5-heptanedione, 2,2,6,6-tetramethyl-3,5-heptanedione, 1-(Thiophen-2-yl)butane-1,3-dione, 4,4,4-Trifluoro-1-(2-thienyl)-1,3-butanedione, 4,4,4-Trifluoro-1-(2-furyl)-1,3-butanedione, 1-Phenyl-1,3-butanedione, 4,4,4-Trifluoro-1-phenyl-1,3-butanedione, 4,4,4-Trifluoro-1-(4-methylphenyl)butane-1,3-dione, 4,4,4-Trifluoro-1-(2-naphthyl)-1,3-butanedione, 1,3-Diphenyl-1,3-propanedione, 1,3-Di(2-pyridyl)-1,3-propanedione, and combinations thereof.

15. The method of claim 9, wherein the element is a transition metal selected from the group consisting of Sc³⁺, Ti³⁺, V⁴⁺, Cr³⁺, Mn³⁺, Fe³⁺, Co³⁺, Ni²⁺, Cu²⁺, Zn²⁺, Ga³⁺, Ge⁴⁺, Sr²⁺, Y²⁺, Zr⁴⁺, Nb³⁺, Ru⁴⁺, Pd²⁺, Cd²⁺, Sn⁴⁺, Hf⁴⁺, Bi³⁺, and combinations thereof.

16. The method of claim 9, wherein the element is a rare earth element selected from the group consisting of La³⁺, Ce³⁺, Ce⁴⁺, Pr³⁺, Nd³⁺, Pm³⁺, Sm³⁺Eu³⁺, Gd³⁺, Tb³⁺, Dy³⁺, Ho³⁺, Er³⁺, Tm³⁺, Yb³⁺, Lu³⁺, Th³⁺, U⁴⁺, and combinations thereof.

17. A method of determining a flow characteristic of a formation or an attribute of a fluid in a formation, comprising:
introducing an injection fluid comprising one or more oil-soluble carbon dots into an injection well associated with a formation at a first location;
recovering produced fluid from a production well associated with the formation at a second location;
detecting the presence of the one or more of oil-soluble carbon dots in the produced fluids; and
determining at least one flow characteristic of the formation or an attribute of the fluid in the formation between the first and the second location based upon the detection of the one or more oil-soluble carbon dots.

18. The method of claim 17, wherein the oil-soluble carbon dots comprise an element selected from the group consisting of a transition metal, a rare earth element, and combinations thereof.

19. The method of claim 17, wherein the presence of the one or more oil-soluble carbon dots is detected using at least one of fluorescence spectroscopy, inductively coupled plasma atomic emission spectroscopy, and inductively coupled plasma mass spectrometry.
